(19) United States
(12) Patent Application Publication
(10) Pub. No.: US 2008/0194307 A1
(43) Pub. Date: Aug. 14, 2008

(54) SPORTS-BASED GAME OF CHANCE

(76) Inventor: Jeff Sanger, Parma, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/027,536

(22) Filed: Feb. 7, 2008

Related U.S. Application Data
(60) Provisional application No. 60/889,676, filed on Feb. 13, 2007.

(51) Int. Cl. A63F 13/00

(52) U.S. Cl. 463/4

(57) ABSTRACT

A sports-based game of chance includes a game board associated with a predetermined sport, where the game board including a plurality of spaces representative of an order of play for players of the game and an area designated for wagers by the players. A first random number generator generates numbers for determining an order of play. The sports-based game of chance is governed by rules including mandatory wagering by all players based on the start of a given player's turn, changing of a player's turn based on a first set of normally-occurring random events during the predetermined sport, wagering payout to a player based on a second set of normally-occurring random events during the predetermined sport during a given player's turn to play.

### CROSS-REFERENCE TO RELATED APPLICATIONS

This application claims benefit of U.S. Provisional Application No. 60/889,676, filed on Feb. 13, 2007, which is incorporated herein by reference in its entirety.

### TECHNICAL FIELD

The present invention relates generally to games, such as board games and electronically-implemented games, and, more particularly, to a sports-based game of chance having rules governed by normally-occurring events during a given sporting event.

### BACKGROUND

People enjoy watching sporting events of all types. In addition, many people enjoy wagering on sporting events—whether the wagering includes a visit to a casino's sportsbook, or simply an informal bet between friends. In addition, many people still enjoy playing board games or other home-based games.

### SUMMARY

One aspect of the disclosure relates to a sports-based game of chance that includes a game board associated with a predetermined sport, the game board including a plurality of spaces representative of an order of play for players of the game and an area designated for wagers by the players and a first random number generator that generates numbers for determining an order of play, wherein the game is governed by rules including mandatory wagering by all players based on the start of a given player's turn, changing of a player's turn based on a first set of normally-occurring random events during the predetermined sport, wagering payout to a player based on a second set of normally-occurring random events during the predetermined sport during a given player's turn to play.

Another aspect of the disclosure relates to a sports-based game of chance that includes a game board associated with a predetermined sport, the game board including a plurality of spaces representative of an order of play for players of the game and an area designated for wagers by the players; and a first random number generator that generates numbers for determining an order of play. The game is governed by rules including (i) mandatory wagering by all players based on the start of a given player's turn, (ii) changing of a player's turn based on a first set of normally-occurring random events during the predetermined sport, (iii) wagering payout to a player based on a second set of normally-occurring random events during the predetermined sport during a given player's turn to play.

Another aspect of the disclosure relates to a program stored on a computer-readable medium, the program being representative of a sports-based game of chance, wherein when the program is loaded onto a computer and executed, the program causes the computer to display a sports-based game of chance. The sports-based game of chance includes a main playing area associated with a predetermined sport, the main playing area including a plurality of spaces representative of an order of play for players of the game and an area designated for wagers by the players; and a random number generator that generates numbers for determining an order of play. The game is governed by rules including (i) mandatory wagering by all players based on the start of a given player's turn, (ii) changing of a player's turn based on a first set of normally-occurring random events during the predetermined sport, (iii) wagering payout to a player based on a second set of normally-occurring random events during the predetermined sport during a given player's turn to play.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a flow diagram illustrating an exemplary series of events during playing of the sports-based game of chance in accordance with one exemplary embodiment;

FIG. 2 is an exemplary schematic depiction of the recording media which may be used in carrying out an exemplary embodiment of the sports-based game of chance;

FIG. 3A is a top view of an exemplary movable marker configured as a representation of a football helmet for use with the sports-based game of chance;

FIG. 3B is an exemplary perspective view of a wagering token for use with the sports-based game of chance;

FIG. 3C is a top and bottom view of an exemplary random number generator for use with the sports-based game of chance;

FIG. 3D is a perspective view of another exemplary random number generator for use with the sports-based game of chance;

FIG. 4 is a top view of an exemplary game board, which is configured as a representation of a football field, for use with the sports-based game of chance;

FIG. 5 is a schematic depiction of an exemplary electronic environment in which the sports-based game of chance can be played; and

FIG. 6 is a perspective view of a computer screen within an electronic environment in which the sports-based game of chance can be played.

### DETAILED DESCRIPTION

The present disclosure describes a sports-based game of chance in which various aspects the game play are determined by normally-occurring events that occur randomly throughout the predetermined sport on which the game is based.

With reference to the figures, the sports-based game of chance is shown in an exemplary environment relating to the sport of football. In other words, the game will be played in conjunction with the viewing of all or a portion of a football game (and the outcome of the sports-based game of chance will be determined by a plurality of normally-occurring random events during the football game). It will be appreciated that such environment is only for use of embodying the principles and concepts of the game. It is further understood that the game can be played in relation to a multitude of sports and is not limited to the football environment embodiment. Suitable sports include, but are not limited to, football, baseball, basketball, hockey, soccer, tennis, golf, racing and the like.

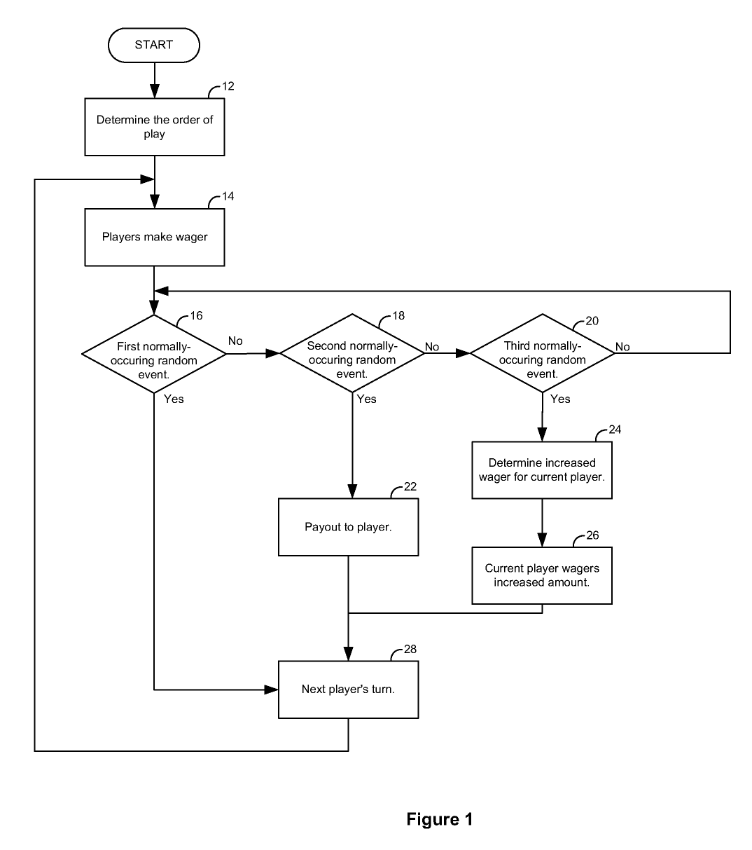

While for purposes of simplicity of explanation, the flow chart or functional diagram of FIG. 1 includes a series of steps, events or functional blocks that represent one or more aspects of the relevant operation of the sports-based game of chance, it is to be understood and appreciated that aspects of the invention described herein are not limited to the order of steps, events or functional blocks, as some steps, events or functional blocks may, in accordance with aspects of the present invention, occur in different orders and/or concurrently with other steps, events or functional blocks from that shown or described herein. Moreover, not all illustrated steps, events or functional blocks of aspects of relevant operation may be required to implement a methodology in accordance with an aspect of the invention. Furthermore, additional steps, events or functional blocks representative of aspects of relevant operation of the sports-based game of chance may be added without departing from the scope of the present invention.

Turning to FIG. 1, the flow diagram illustrates an exemplary series of steps, events or functional blocks in connection with playing of the sports-based game of chance. As is discussed above, the exemplary series of game playing will take place in conjunction with the viewing of a football game by the players who are playing the sports-based game of chance.

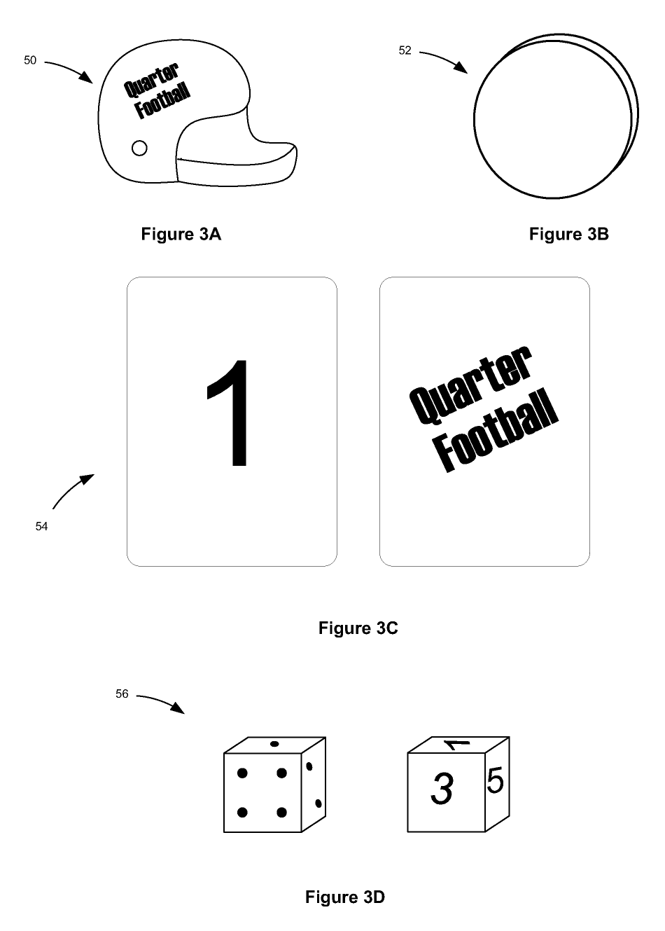

At step 12, the order of play for players of the game is determined randomly, e.g., using a first random number generator. In one embodiment, the first random number generator may be a plurality of numbered cards to be chosen by players. FIG. 3C illustrates an example of the first random number generator shown as numbered card 54, belonging to a plurality of numbered cards for random number generation. Alternatively, another suitable random number generator may be employed, such as a numbered die (see FIG. 3D).

Turning back to FIG. 1, step 14 identifies the next step in the exemplary game play process where all of the players make a wager before each player's turn. In one embodiment, all players wager at least one token into a community pot from which the winnings will be divided. At step 16, the current player, while watching the sporting event, waits until an event occurs that triggers or otherwise governs play of the sports-based game of chance. In the illustrated embodiment, if the event falls within a first set of normally-occurring random events, the player will lose his/her turn, and the game will move to the next player's turn to play (step 28).

It will be appreciated that the first set of normally-occurring random events will depend upon the particular sport in connection with which the sports-based game of chance is being played. For example, during a football game, the first set of normally-occurring random events may include a change of possession (e.g., a punt or a change of downs). Alternatively, the game may move from player to player based after each play or after an incomplete pass or the like. In other words, the sports-based game of chance may vary in terms of which normally-occurring random events trigger certain actions within the sports-based game of chance without departing from the scope of the present invention.

If the occurring event is not within the first set of normally-occurring random events, the game moves to step 18 where it is determined whether the occurring event is within a second set of normally-occurring events. As is discussed above, it will be appreciated that the second set of normally-occurring random events will depend upon the particular sport in connection with which the sports-based game of chance is being played. In the exemplary embodiment in which the sporting event is a football game, the second set of normally-occurring events may include scoring events (e.g., the scoring of a touchdown, field goal or safety). If the particular event is within the second set of normally-occurring events, the current player will receive a percentage of the community pot tokens (step 22) depending on what type of normally-occurring random event occurs. For example, if the offensive team scores a touchdown, the current player may win the entire community pot of wagered tokens (or some other predetermined portion of the community pot of wagered tokens). In another example, if the offensive team scores a field goal in a predetermined range of yards, the current player may win a corresponding portion of the community pot of wagered tokens (e.g., a field goal under forty (40) yards may award the player half of the community pot, while a field goal over forty (40) yards may award the player all of the community pot). Following a scoring event, the game will proceed to the next player's turn (step 28).

If a random event occurs that is not within the second set of normally-occurring events, the random event may fall within a third set of normally-occurring events at step 20. As is discussed above, it will be appreciated that the third set of normally-occurring random events will depend upon the particular sport in connection with which the sports-based game of chance is being played. In the exemplary embodiment in which the sporting event is a football game, the third set of normally-occurring events may include turnover or other negative play for the offensive team (e.g., an interception, a missed field goal, a blocked field goal or a blocked punt).

After such an occurrence of an event within the third set of normally-occurring random events, the current player (at step 24) determines the amount of a mandatory increased wager. For example, the player may use a random number generator (e.g., a stack of numbered cards (FIG. 3C) or a numbered die 56 (FIG. 3D)) to determine the player's increase wager of tokens into the community pot. After the second random number generator determines the number of tokens to be wagered, the current player wagers the increased amount of tokens into the community pot (step 26). After the occurrence of an increased wager (step 26), the game proceeds to the next player's turn (step 28)—which was determined at the beginning of the game. At this point, the game play commences at step 14, wherein all players wager at least one token into the community pot and proceed to steps 16, 18, 20, etc.

The game may continue during all or part of a predetermined sporting event or may carry on over several sporting events (e.g., a football double-header).

It will be appreciated that the sports-based game of chance may include a variety of modifications without departing from the scope of the present invention. One variation may include a bonus scoring and/or wagering element in which one or more players randomly draw bonus cards. A bonus card may provide for a player winning a bonus (e.g., each other player contributing an additional token into the community pot upon the occurrence of a bonus-triggering event). In the exemplary football-based embodiment, the bonus card may provide for a bonus payout upon the occurrence of a certain event (e.g., a score by a wide receiver if a player is holding a wide receiver card). Other variations will be contemplated by skilled artisans upon reading the present disclosure.

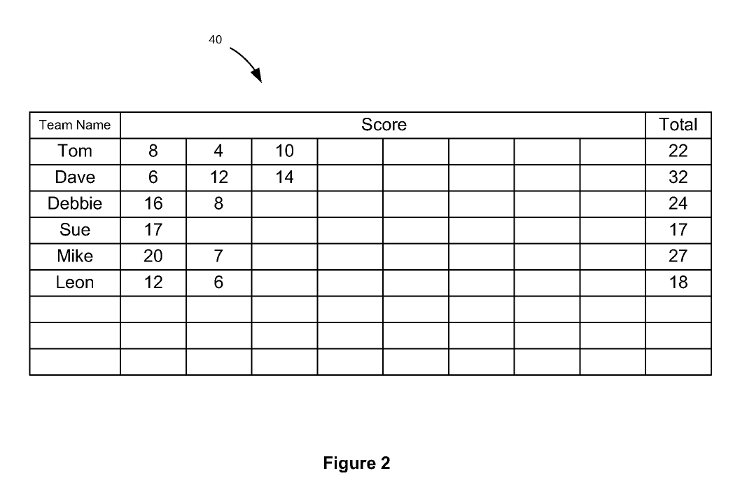

FIGS. 2-4 show exemplary pieces or game equipment to be used for playing the sports-based game of chance. It will be appreciated that the invention is not limited to a particular game board configuration, scoring or recording media configuration and/or random number generator configuration. Rather, the principles of the sports-based game of chance may be carried out regardless of the artwork or other representations found on the game board, scoring or recording media and/or random number generator(s).

Turning to FIG. 2, an example of a recording media for recording each player's score during the game is shown as a scorecard. The exemplary score card lists the each player's name as a corresponding team name and leaves a substantial amount of room for an undetermined number of normally-occurring random events that may occur throughout the game. It is understood that multiple scorecards can be used during the game play, if need be. In addition, the sports-based game of chance may be enjoyed with any type of scoring or recording medium (or without a scoring or recording medium at all) without departing from the scope of the present invention.

FIG. 3A shows the top view of an exemplary movable marker which is representative of a football helmet. The marker, which marks or otherwise indicates the current player's turn, is preferably any object representative of the sport being played. It will be appreciated that any suitable marker may be used (or no marker may be used at all) without departing from the scope of the present invention. As is discussed below, the marker may not be a physical object in the electronic environment of play.

FIG. 3B shows the perspective view of a wagering token 52. This wagering token belongs to a set of wagering tokens that may vary in size, shape and color and be distributed to each player at the outset of the game. The tokens will be wagered by the player or to paid out to the player at the outset of the game, or after the occurrence of any one of the sets of first, second or third normally-occurring random events. In one embodiment, the tokens may be poker chips. With the increased popularity of poker, many users are comfortable with using and/or handling poker chips. Of course, it will be appreciated that the wagering tokens may take on any suitable shape or designation without departing from the scope of the present invention. Further, the wagering tokens may be replaced with cash (e.g., quarters, nickels and the like).

FIG. 3C shows the front and back view of an exemplary first random number generator, which is represented by numbered card 54. Numbered card 54 belongs to a set of numbered cards that may be used as the first number generator for determining the order of players at the outset of the game and/or for determining the increased wager a player must wager into the community pot after the occurrence of an event within the third set of normally-occurring events.

FIG. 3D is a perspective view of an exemplary second random number generator, which is represented by numbered die 56. Numbered die 56 may be used as the second random number generator for determining the increased wager a player must wager into the community pot after the occurrence of an event within the third set of normally-occurring random event or for determining the order of players at the outset of the game.

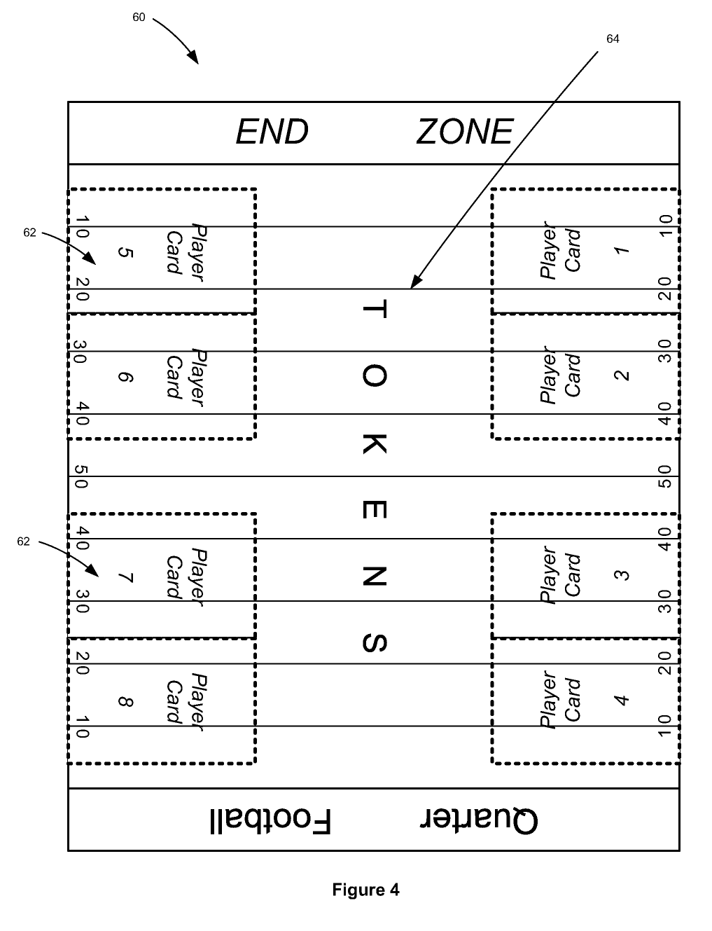

FIG. 4 shows a top view of an exemplary game board 60 of the sports-based game of chance that has been configured to represent a football field. At positions 62, each player can place their respective numbered card 54 from the set of numbered cards that randomly determined their order. At position 64, space is provided for the community pot of tokens to be placed, wherein the wagered tokens may be added conveniently by each player or withdrawn by each player, depending on the occurrence of an event within the second and/or third sets of normally-occurring random events during the game play. It is understood that this is an exemplary positioning of positions 62 and 64, and may be included in another position or excluded completely from the game board.

In addition, the game board 60 may take on a different configuration for a sports-based game of chance being played in connection with a different sport. For example, the game board may be configured as a baseball diamond, a basketball court, a hockey rink or the like. In other words, the sports-based game of chance is not limited to any particular game board configuration. Further, as discussed below, the sports-based game of chance may be practiced without any “physical” game board. Rather, the sports-based game of chance may be practiced in connection with an electronic environment.

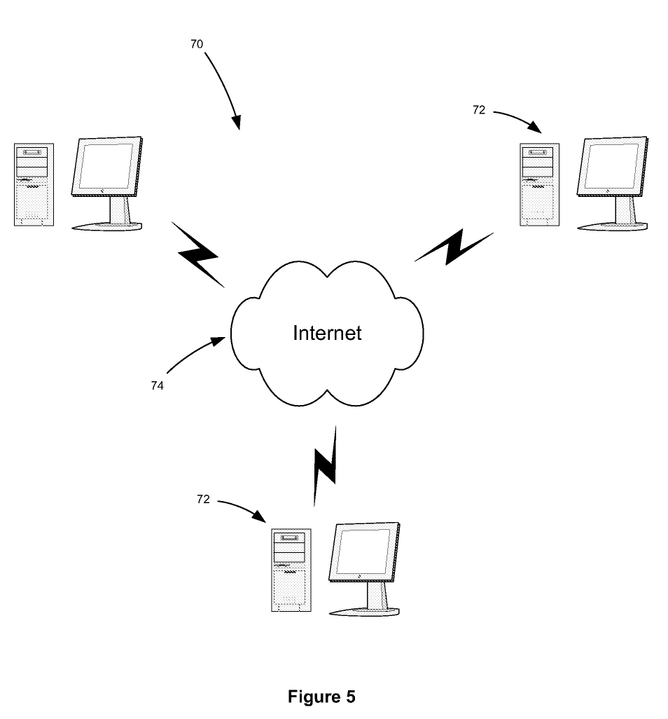

FIG. 5 is a representation of an electronic environment 70, where multiple players are connected over a network or Internet network 74 with the use of computer terminals 72. It is understood that the illustrated exemplary representation of a network or Internet network 74 is not meant to depict the actual number or limit to the number of players that can join this game. It is further understood that each computer terminal 72 does not limit the number of players at that particular terminal to a single player.

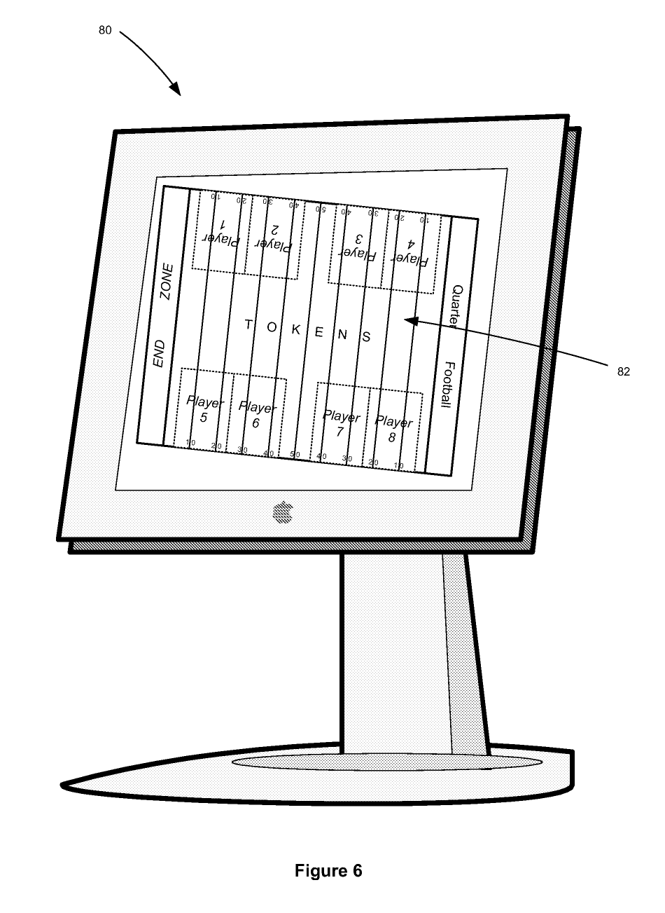

FIG. 6 is an enlarged perspective view of the exemplary computer terminal screen 80 from network or internet network 70, on which an exemplary electronic game board 82 is shown.

As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain illustrated embodiment, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention.

What is claimed is:

1. A sports-based game of chance comprising:
a game board associated with a predetermined sport, the game board including a plurality of spaces representative of an order of play for players of the game and an area designated for wagers by the players;
a first random number generator that generates numbers for determining an order of play;
a plurality of wagering tokens representative of money being wagered;
a recording media for recording the player's scoring during the game;
wherein the game is governed by rules including (i) mandatory wagering by all players based on the start of a given player's turn, (ii) changing of a player's turn based on a first set of normally-occurring random events during the predetermined sport, (iii) wagering payout to a player based on a second set of normally-occurring random events during the predetermined sport during a given player's turn to play.

2. The sports-based game of chance of claim 1, wherein the game is governed by a rule requiring (iv) an increased mandatory wager by the given play whose turn it is to play based on a third set of normally-occurring random events during the predetermined sport.

3. The sports-based game of chance of claim 1, wherein the predetermined sport is football.

4. The sports-based game of chance of claim 1, further comprising a movable marker indicative a given player's turn to play, the movable marker having a graphical representation associated with the predetermined sport.

5. The sports-based game of chance of claim 4, wherein the movable marker is configured as a representation of a football helmet.

6. The sports-based game of chance of claim 4, wherein the movable marker is configured as a representation of a football.

7. The sports-based game of chance of claim 1, wherein the first random number generator is a plurality of numbered cards.

8. The sports-based game of chance of claim 1, further comprising a second random number generator that generates numbers for determining the number of wagering tokens the given player must wager, upon the occurrence of the third set of normally-occurring random events during the predetermined sport.

9. The sports-based game of chance of claim 8, wherein the second random number generator is a numbered die.

10. The sports-based game of chance of claim 1, wherein the wagering tokens are poker chips.

11. The sports-based game of chance of claim 1, wherein the game is represented in an electronic environment.

12. The sports-based game of chance of claim 3, wherein the first set of normally-occurring random events includes:
the scoring of a touchdown;
the scoring of a field goal;
the scoring of a safety;
the occurrence of a fumble;
the occurrence of an interception;
the occurrence of a blocked punt;
the occurrence of a blocked field goal;
the occurrence of a missed field goal; and/or
the occurrence of a change of downs.

13. The sports-based game of chance of claim 3, wherein the second set of normally-occurring random events includes:
the scoring of a touchdown;
the scoring of field goal over a predetermined distance;
the scoring of a filed goal under a predetermined distance; and/or the scoring of a safety.

14. The sports-based game of chance of claim 3, wherein the third set of normally-occurring random events includes:
the occurrence of a fumble;
the occurrence of an interception;
the occurrence of a blocked punt;
the occurrence of a blocked field goal;
the occurrence of a missed field goal; and/or
the occurrence of a change of downs.

15. The sports-based game of chance of claim 1, wherein the game board is configured as a representation of a football field.

16. The sports-based game of chance of claim 1, wherein the predetermined sport is baseball.

17. The sports-based game of chance of claim 1, wherein the predetermined sport is basketball.

18. The sports-based game of chance of claim 1, wherein the predetermined sport is hockey or soccer.

19. A sports-based game of chance comprising:
a game board associated with a predetermined sport, the game board including a plurality of spaces representative of an order of play for players of the game and an area designated for wagers by the players; and
a first random number generator that generates numbers for determining an order of play;
wherein the game is governed by rules including (i) mandatory wagering by all players based on the start of a given player's turn, (ii) changing of a player's turn based on a first set of normally-occurring random events during the predetermined sport, (iii) wagering payout to a player based on a second set of normally-occurring random events during the predetermined sport during a given player's turn to play.

20. A program stored on a computer-readable medium, the program being representative of a sports-based game of chance, wherein when the program is loaded onto a computer and executed, the program causes the computer to display a sports-based game of chance, wherein the sports-based game of chance includes:
a main playing area associated with a predetermined sport, the main playing area including a plurality of spaces representative of an order of play for players of the game and an area designated for wagers by the players; and
a random number generator that generates numbers for determining an order of play;
wherein the game is governed by rules including (i) mandatory wagering by all players based on the start of a given player's turn, (ii) changing of a player's turn based on a first set of normally-occurring random events during the predetermined sport, (iii) wagering payout to a player based on a second set of normally-occurring random events during the predetermined sport during a given player's turn to play.
